(19) United States
(12) Patent Application Publication
(10) Pub. No.: US 2025/0215259 A1
(43) Pub. Date: Jul. 3, 2025

(54) FILAMENT CONTAINING POLYAMIDE (PA) POLYMER AND ITS USE FOR ADDITIVE MANUFACTURING

(71) Applicant: SOLVAY SPECIALTY POLYMERS USA, LLC, ALPHARETTA, GA (US)

(72) Inventors: Stéphane JEOL, Saint-Genis-Laval (FR); Christopher WARD, Sandy Springs, GA (US); Arthur René Henri BERTRAND, VILLETTE DE VIENNE (FR); Véronique BOSSENNEC, SEREZIN-DU-RHÔNE (FR)

(73) Assignee: SOLVAY SPECIALTY POLYMERS USA, LLC, ALPHARETTA, GA (US)

(21) Appl. No.: 18/851,033

(22) PCT Filed: Mar. 24, 2023
(86) PCT No.: PCT/EP2023/057648

§ 371 Date: Sep. 25, 2024

Related U.S. Application Data
(60) Provisional application No. 63/323,514, filed on Mar. 25, 2022.

(30) Foreign Application Priority Data
Apr. 25, 2022 (EP) 22169722.0

(51) Int. Cl. C09D 177/06; B33Y 70/00; C08G 69/26

(52) U.S. Cl. CPC C09D 177/06; B33Y 70/00; C08G 69/26

(57) ABSTRACT

The present invention relates to a process for manufacturing a three-dimensional (3D) article, part or composite material, from a filament comprising a polyamide (PA) presenting 4,4′-diaminodicyclohexylmethane moieties, as well as to such filament. The present invention also relates to the 3D article, part or composite material obtainable from such process, as well as the use of the article, part or composite materials in oil and gas applications, automotive applications, electric and electronic applications, aerospace, medical and consumer goods.

This application is a national stage entry under 35 U.S.C. § 371 of International Application No. PCT/EP2023/057648 filed on Mar. 23, 2023, which claims priority to U.S. provisional application No. 63/323,514 filed on Mar. 25, 2022 and European patent application No. 22169722.0 filed on Apr. 25, 2022. The entire contents of these applications are explicitly incorporated herein by this reference.

The present invention relates to a filament based on a polyamide (PA) comprising 4,4′-diaminodicyclohexylmethane moieties, as well as to a process for manufacturing a three-dimensional (3D) article, part or composite material, from such filaments.

### TECHNICAL FIELD

Many objects, from household items to motor parts, are produced either from a single mass of material or they are milled or carved from a larger block of material. An alternative approach to manufacture objects is to deposit a layer of material, and then add another layer on top, followed by another and another, and so on. This process of adding gave rise to the name additive manufacturing (AM), more commonly known as 3D printing. The range of specially designed 3D-printed products on the market is now considerable—from motor parts to dental implants. They can be notably manufactured using plastics. It is expected that additive manufacturing will disrupt established practices and overturn conventional assumptions about mass production in distant factories. Local fabrication in small volumes, or even of single items, close to the end user will become viable.

In an extrusion-based AM system, a 3D part is printed from a digital representation of the 3D part in a layer-by-layer manner by extruding and adjoining strips of a part material. The part material is extruded through an extrusion tip carried by a print head of the system, and is deposited as a sequence of roads on a platen in an x-y plane. The extruded part material fuses to previously deposited part material, and solidifies upon a drop in temperature. The position of the print head relative to the substrate is then incremented along a z-axis (perpendicular to the x-y plane), and the process is then repeated to form a 3D part resembling the digital representation. An example of extrusion-based AM system starting from filaments is called Fused Filament Fabrication (FFF), also known as Fused Deposition Modelling (FDM).

One of the fundamental limitations associated with known extrusion-based AM methods using polymeric part material in the form of filaments is based on the lack of identification of polymeric material presenting the right set of properties, in order to print articles, parts or composite materials with acceptable properties, notably thermal and mechanical properties.

Certain polyamides are used for manufacturing articles by extrusion-based 3D printing. Mention can for example be made of polyamide 12 (PA12) and polyamide 6 (PA6). These polyamides advantageously have a melting temperature (Tm) lower than 280° C., and therefore have a much broader temperature window for their synthesis and processing in the melt, which first offers more flexibility in synthesis and processing, but also leads to printed parts with less colouring due to degradation. These polyamides however usually exhibit a low glass transition temperature (Tg), e.g. below 50° C., which make them unsuitable to prepare articles used in applications requiring a high temperature resistance as their mechanical properties, such as modulus or strength, fall significantly above this temperature. For example, PA12 has a Tg of 40° C. and PA6 has a Tg of 50° C. Moreover, PA 6 absorbs so much moisture when exposed to ambient environment or when it is soaked in water (around 9 wt. %) that its Tg decreases dramatically and parts made with PA 6 have lower modulus when exposed at temperatures above room temperature. In addition, these polyamides and their filaments require a drying step before being used.

### Technical Problem

Some applications sometimes require the preparation with FFF of 3D objects exhibiting a combination of good mechanical properties (e.g. modulus and strength) and other physico-chemical properties, even at high temperatures. For instance, articles to be used in applications like automotive interior and exterior need to withstand temperatures as high as 80° C. These properties should also not be affected by the humidity present in the environment.

The filament used in the 3D printing process should also be easily processable with the available 3D printers.

The 3D object should also exhibit UV and chemical resistance. UV resistance is for instance needed when the 3D object is to be left outdoors or under sunlight.

Finally, customers are more and more sensitive to using materials prepared from biobased components. Some customers are also interested in preparing 3D objects being translucent or transparent.

The filament of the invention addresses this technical problem.

### BACKGROUND ART

U.S. Pat. No. 5,360,891 (Huels) relates to a colourless and transparent, amorphous processable polyamide comprising the reaction product of I. a linear aliphatic dicarboxylic acid; II. a) 35-60 mol % of trans, trans-bis(4-aminocyclohexyl)-methane; and II. b) 65-40 mol % of other aliphatic, cycloaliphatic, araliphatic or aromatic diamines as starting components.

US 2015/0099847 (Evonik) relates to a composition, comprising a blend of two polyamides wherein one of them is a polyamide having as copolymerized units bis(4-aminocyclohexyl) methane (PACM) and a linear dicarboxylic acid having from 8 to 18 C atoms. There is no mention of a filament.

U.S. Pat. No. 8,399,557 (Arkema) relates to a transparent blend or alloy comprising from 1 to 99 wt. % of a copolymer comprising two types of units: (A1) amide units, including at least one cycloaliphatic unit and (A2) flexible ether units, wherein the cycloaliphatic diamine or diamines can be chosen from bis(3-methyl-4-aminocyclohexyl) methane (BMACM), para-aminodicyclohexylmethane (PACM), isophoronediamine (IPD), bis(4-aminocyclohexyl) methane (BACM), 2,2-bis(3-methyl-4-aminocyclohexyl) propane (BMACP) or 2,6-bis(aminomethyl)norbornane (BAMN).

WO 2021/160959 discloses polyamide in the powder form for 3D printing.

US 2021/0040318 discloses a blend comprising an amorphous polyamide and a crystalline polyamide for 3D printing. The crystalline polyamide may be PACM12.

U.S. Pat. No. 3,393,210 (Dupont, 1968) describe a fiber-forming polycarbonamide (including copolycarbonamide) presenting the following recurring unit:

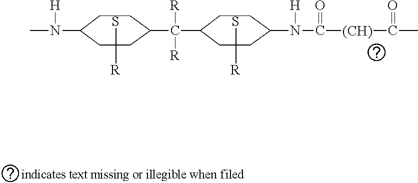

GB 1150860 (D1) discloses crystalline polyamide filaments in the field of textiles. D1 discloses and covers a crystalline oriented filament of a high molecular weight of formula:

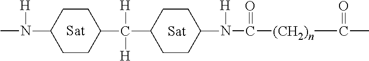

where n is 9-14 and where at least 70 wt % of the diamino constituent has a trans-trans configuration. The bis(4-aminocyclohexyl)methane used for the preparation of the polyamide of D1 comprises a proportion of 70 to 100 wt % of trans-trans stereoisomer. The proportion of trans/trans for the polyamide (PA) is lower than 70 wt %.

WO 2019/170463 (D2) belongs to the field of 3D printing and discloses and covers a filament comprising a core material coated with a layer of shell material, wherein the core material and the shell material each comprises the components at least one fibrous filler, at least one thermoplastic polymer, and optionally at least one additive. The thermoplastic polymer of the core may be PACM 12. D2 thus discloses a filament made of a polymer composition which is not homogeneous. Moreover, there is no information about the proportion of trans-trans in PACM 12.

U.S. Pat. No. 11,148,374 (D3) belongs to the field of 3D printing and discloses a polymeric-based material configured for use as a feedstock in an extrusion-based additive manufacturing system, the material comprising a substantially uniform blend of one or more semicrystalline polyamides and one or more amorphous polyamides, wherein the one or more amorphous polyamides and one or more fillers comprising from about 1 wt % to about 45 wt % of the total weight of the polymeric based material.

None of these patent documents describe the use of a filament as claimed.

### Brief Disclosure of the Invention

The invention is as disclosed in the appended set of claims.

The present invention relates to a filament.

The invention also relates to a spool of filament.

The present invention relates to a method and to the use of the filament of the invention.

More details and precisions for all these subject-matters are given below.

### DISCLOSURE OF THE INVENTION

### Filament of the Present Invention

The filament is as disclosed in claim 1. This filament is made of or comprises a polymer composition (P) which comprises at least 50.0 wt. % (based on the total weight of the polymer composition (P)) of at least one polyamide (PA) comprising the recurring units (R_{PA}) of formula (I):

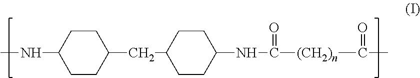

wherein:
the proportion of recurring units (R_{PA}) is at least 50.0 mol %, this proportion being relative to the total number of recurring units in the polyamide (PA);
n is an integer between 7 and 11;
at least 30.0 mol. % of the moieties derived from 4,4′-diaminodicyclohexylmethane are in a trans/trans configuration, this proportion being based on the total number of moles of the moieties derived from 4,4′-diaminodicyclohexylmethane in the polyamide (PA).

The filament has a cylindrical or substantially cylindrical geometry.

The filament may have a cylindrical or substantially cylindrical geometry with a diameter d between 0.5 mm and 5.0 mm. d may vary between 0.8 and 4.0 mm or between 1.0 mm and 3.5 mm.

d can be chosen to feed a specific FFF 3D printer. An example of diameter used extensively in FFF process has a diameter d of 1.75 mm or 2.85 mm.

Preferentially, the filament has a round cross-section.

The expression “filament” refers to a thread-like object or fiber or strand formed.

Preferably, the filament is a full filament. The term “full” is used in comparison to a hollow geometry and denotes a filament which is not hollow.

According to a preferred embodiment, the filament does not present a core/shell geometry with another polymeric composition. The “core/shell geometry” refers to a filament having an elongated core radially surrounded by an outer shell. The core and the shell are generally made of two different polymer compositions or of two polymers of the same composition but with distinct physico-chemical properties.

The core/shell geometry requires the use of a more complex coextrusion system than a simple extrusion system. Moreover, during the 3D printing process, the material(s) of the shell are mixed with the material(s) of the core and this results in several anticipated technical difficulties (inhomogeneity of the composition of the 3D object, contamination with the material(s) of the shell, etc).

To avoid the inhomogeneity described above, the components of the composition (P) are preferably blended together. The term “blend” is intended to denote a homogeneous (or uniform) physical mixture. The term “blended” is intended to mean that the components, notably of the polymer composition (P), form an homogeneous (or uniform) physical mixture.

Preferably, the composition of the filament consists of the polymer composition (P).

The length L of the filament is generally at least 200 mm.

The filament may be in the form of a spool. The invention thus also relates to a spool of the filament of the invention. The spool is made of or comprises the polymer composition (P).

### About the Polymer Composition (P)

The polymer composition (P) comprises at least 50.0 wt. % (based on the total weight of the polymer composition (P)) of at least one polyamide (PA) which is disclosed herein.

The polymer composition (P) may comprise one or more polyamide (PA) as described herein. It may comprise more than one polyamide (PA). In this case, the polyamide(s) (PA) are blended together.

Preferably, the polymer composition (P) comprises only one polyamide (PA) as described herein.

Preferably, the polymer composition (P) is free of an aromatic polyamide. Preferably, the polymer composition (P) is free of an amorphous polyamide. An aromatic polyamide is a polyamide comprising recurring units having an aromatic moiety. An amorphous polyamide is a polyamide having a heat of fusion Hm lower than 2.0 J/g. The expression “free of X” means that the polymer composition (P) does not comprise X or if it comprises X, the proportion of X in the composition (P) is less than 1.0 wt %, preferably less than 0.5 wt %, preferably less than 0.1 wt %.

Preferably, the polymer composition (P) is free of a polyamide other than the polyamide(s) (PA). Preferably, the polymer composition (P) does not comprise a polyamide other than the polyamide(s) (PA).

The proportion of the polyamide(s) (PA) in the polymer composition (P) is at least 50.0 wt. %. This proportion may be at least 60.0 wt. %, preferably at least 70.0 wt. %, preferably at least 80.0 wt. %. The proportion of the polyamide(s) (PA) may be between 50.0 wt. % and 100.0 wt. %.

The polymer composition (P) may also comprise at least one thermoplastic polymer other than the polyamide(s) (PA). In this case, the polyamide(s) (PA) and the thermoplastic polymer(s) are blended together. The thermoplastic polymer may be selected from the group consisting of poly(arylene sulphide) (PAS) polymers, for example homopolymer of poly(phenylene sulphide) (PPS) polymer, poly(aryl ether sulfone) (PAES) polymers, for example a poly(biphenyl ether sulfone) (PPSU) polymer or a polysulfone (PSU) polymer, a polyetherimide (PEI), and poly(aryl ether ketone) (PAEK) polymers, for example a poly(ether ether ketone) (PEEK) polymer.

The polymer composition (P) may also comprise at least one additive selected from the group consisting of fillers, colorants, dyes, pigments, lubricants, plasticizers, flame retardants, tougheners, nucleating agents, heat stabilizers, light stabilizers, antioxidants, processing aids, fusing agents, electromagnetic absorbers and combination thereof.

The filler may be more particularly selected in the group consisting of continuous or chopped carbon fibers, continuous or chopped glass fibers, milled carbon fibers, milled glass fibers, glass beads, glass microspheres, wollastonite, silica beads, talc, calcium carbonates, biobased fibers, polymeric fibers and combination thereof.

The synthetic polymeric fibers are for instance aramid fibers, rock wool fibers, natural fibers (e.g. linen, hemp, cellulose, or nanocellulose), and any combination of two or more thereof.

The filler is more particularly a carbon fiber, notably selected in the group consisting of continuous carbon fibers, chopped carbon fibers and milled carbon fibers.

The flame retardant may be an halogen-based flame retardant or a phosphorous-based flame retardant. The phosphorous-based flame retardant may be selected in the group consisting of metal alkyl phosphinates. An example of metal alkyl phosphinate is aluminum diethyl phosphinate, for instance the one known under the trade name Exolit® from Clariant. Another example of phosphorous-based flame retardant which makes it possible to have 3D objects of good quality while ensuring a good level of flame retardancy is disclosed below:

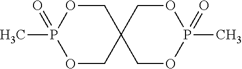

The heat stabilizer may be more particularly selected in the group consisting of mono- or divalent coppers, stabilizers based on secondary aromatic amines, stabilizers based on sterically hindered phenols, phosphites, phosphonites, metal salts, metal oxides and combination thereof.

According to an embodiment, the polymer composition (P) comprises at least one additive selected from the group consisting of fillers that are not fibrous fillers, colorants, dyes, pigments, lubricants, plasticizers, flame retardants, tougheners, nucleating agents, heat stabilizers, light stabilizers, antioxidants, processing aids, fusing agents, electromagnetic absorbers and combination thereof.

According to another embodiment, the polymer composition (P) comprises at least one additive selected from the group consisting of colorants, dyes, pigments, lubricants, plasticizers, flame retardants, tougheners, nucleating agents, heat stabilizers, light stabilizers, antioxidants, processing aids, fusing agents, electromagnetic absorbers and combination thereof.

The polymer composition (P) may more particularly comprise or consist of:
at least one polyamide (PA) as defined herein;
optionally at least one filler as defined herein; and
optionally at least one additive other than a filler as defined herein.

The additive(s) (e.g. filler(s) and/or additive(s) other than a filler) are generally blended with the polyamide(s) (PA) of the polymer composition (P).

The proportion of the additive(s) (e.g. filler(s) and/or are additive(s) other than a filler) in the polymer composition (P) is generally lower than 50.0 wt %, even lower than 40.0 wt % or lower than 30.0 wt. %. The proportion of the additive(s) in the polymer composition (P) is generally between 0.01 and 50.0 wt %, even between 0.10 and 40.0 wt % or between 0.50 and 40.0 wt. %.

More particularly, the invention also relates to a polymer composition (P*) which comprises at least one polyamide (PA) as defined herein, at least one filler and optionally at least one additive other than a filler. The total proportion of filler(s) and the optional additive(s) is generally lower than 50.0 wt %, even lower than 40.0 wt % or lower than 30.0 wt. %. The proportion of the optional additive(s) is usually between 0.01 wt. % and 20.0 wt. %, preferably between 0.1 wt. % and 10.0 wt. %. The filler may be one of the fillers disclosed above.

According to a specific embodiment (E), the filament of the invention is made of a polymer composition (P) consisting of:
at least one polyamide (PA) as defined herein;
optionally at least one filler as defined herein; and
optionally at least one additive other than a filler as defined herein.

The components of the polymer composition (P) are preferably blended together.

### About the Polyamide (PA)

The polyamide (PA) is as disclosed in the claims. Polyamide (PA) comprises the recurring units (R_{PA}) according to formula (I):

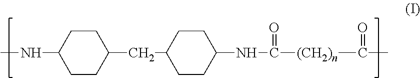

where n is an integer between 7 and 11.

Polyamide (PA) advantageously exhibits the following property/ies:
a glass temperature (Tg) higher than 120° C.; and/or
a melting temperature (Tm) lower than 280° C.

In formula (I), n varies from 7 to 11. n is an integer which may take any value in the range 7-11.

n may more particularly be selected in the group consisting of {7, 8, 9, 10, 11 and combination of two or more of said values}.

n may more particularly be selected in the group consisting of {7, 8, 9, 10, 11}.

n may more particularly take any value as disclosed in one of the examples.

n may more particularly be 11 or an integer from 7 to 9.

The polyamide (PA) is such that at least 30.0 mol. % of the moieties (present in the polyamide) derived from 4,4′-diaminodicyclohexylmethane are in a trans/trans configuration, this proportion being based on the total number of moles of the moieties derived from 4,4′-diaminodicyclohexylmethane in the PA. This proportion makes it possible to have a semi-crystalline polyamide.

The proportion of trans/trans higher than 30.0 mol. % makes it possible to have a semi-crystalline polyamide (PA) that is well suitable for additive manufacturing (3D printing). In particular, the polyamide (PA) of the invention exhibits suitable thermal properties, in particular a high glass transition temperature and a low melting point which ensures a good processing when printing, and advantageously differencing them from most of the commercially available polyamides, such as PA12 (Tg<50° C.) and PA6 (Tg<60° C., hydrophilic). The PA described herein also advantageously presents a low water uptake which contributes to maintain a high glass transition temperature.

The proportion of 4,4′-diaminodicyclohexylmethane moieties in a trans/trans configuration is preferably at least 40.0 mol. %, more preferably at least 50.0 mol. %. This proportion may be lower than 70.0 mol. %, preferably lower than 65.0 mol %, preferably lower than 60.0 mol. %, even more preferably lower than 55.0 mol %.

The proportion of 4,4′-diaminodicyclohexylmethane moiety in a trans/trans configuration may be between 30.0 mol. % and 50.0 mol. % (this latter value being excluded).

The PA described herein comprises at least 50.0 mol. % of the (R_{PA}) recurring units. The proportion of recurring units are expressed in mol % and are relative to the total number of recurring units in the polyamide (PA). The proportion of the recurring units (R_{PA}), based on the total number of recurring units in the polyamide (PA), may be at least about 60.0 mol. %, more particularly at least about 75.0 mol. %, more particularly at least about 80.0 mol. %, more particularly at least about 85.0 mol. %, more particularly at least about 90.0 mol. %, more particularly at least about 95.0 mol. % or at least about 98.0 mol. %. This proportion may also be at least 99.0 mol %, even at least 99.5 mol %.

Homopolyamide: according to an embodiment, the polyamide (PA) is a homopolyamide. The recurring units of the polyamide (PA) consist of or consist essentially of the recurring units (R_{PA}). Such polyamide is prepared by polycondensation in the presence of a reaction mixture comprising:
1) 4,4′-diaminodicyclohexylmethane (PACM) of formula (II):

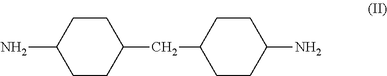 [SMILES: NC1CCC(CC2CCC(N)CC2)CC1]

wherein at least 30.0 mol. % of the PACM are in a trans/trans configuration, based on the total number of moles of PACM in the reaction mixture;
2) at least one diacid of formula (III):

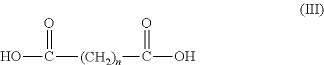

3) and optionally water.

The proportion of trans/trans isomer in the monomer PACM may be controlled by chromatography (e.g. gas chromatography such as GC-FID (flame ionization detector)). Depolymerization of the polyamide in acidic or basic conditions and analysis of the monomers make it possible to determine the proportion of trans/trans moieties in the polyamide.

The condensation mixture also preferably comprises a catalyst, for instance a catalyst containing at least an atom of phosphorus such as sodium hypophosphite.

The condensation mixture must be heated at a high temperature, preferably up to a temperature of at least Tm+10° C., Tm being the melting temperature of the polyamide. The temperature at which the concensation is performed is usually at least 200° C.

The polycondensation is advantageously performed in the melt, notably in the absence of a solvent.

The polycondensation is advantageously performed in a well stirred vessel such as a stirred reactor. The vessel is also advantageously equipped with means to remove the volatile products of reaction. One can conveniently use a stirred vessel to perform the polycondensation.

The conditions used in the examples may be followed and if needs be, adapted for the preparation of other homopolyamides.

Copolyamide: according to another embodiment, the polyamide (PA) is a copolyamide comprising the recurring units (R_{PA}) and also the recurring units (R*_{PA}) according to formula (IV) and/or formula (V):

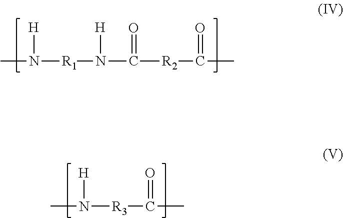

wherein:
R₁ is selected from the group consisting of a C₂-C₁₅ alkylene and a C₆-C₃₀ arylene, optionally comprising one or more heteroatoms (e.g. O, Nor S) and optionally substituted with one or more substituents selected from the group consisting of halogen (e.g. fluorine, chlorine, bromine or iodine), hydroxy (—OH), sulfo (—SO₃M) (e.g., wherein M is H, Na, K, Li, Ag, Zn, Mg or Ca), C₁-C₆ alkoxy, C₁-C₆ alkylthio, C₁-C₆ acyl, formyl, cyano, C₆-C₁₅ aryloxy and C₆-C₁₅ aryl;
R₂ is selected from the group consisting of a C₁-C₂₀ alkylene and a C₆-C₃₀ arylene, optionally comprising one or more heteroatoms (e.g. O, Nor S) and optionally substituted with one or more substituents selected from the group consisting of halogen (e.g. fluorine, chlorine, bromine or iodine), hydroxy (—OH), sulfo (—SO₃M) (e.g., wherein M is H, Na, K, Li, Ag, Zn, Mg or Ca), C₁-C₆ alkoxy, C₁-C₆ alkylthio, C₁-C₆ acyl, formyl, cyano, C₆-C₁₅ aryloxy and C₆-C₁₅ aryl; and
R₃ is a linear or branched C₂-C₁₄ alkylene, optionally comprising one or more heteroatoms (e.g. O, N and S) and optionally substituted with one or more substituents selected from the group consisting of halogen (e.g. fluorine, chlorine, bromine and iodine), hydroxy (—OH), sulfo (—SO₃M) (e.g., wherein M is H, Na, K, Li, Ag, Zn, Mg or Ca), C₁-C₆ alkoxy, C₁-C₆ alkylthio, C₁-C₆ acyl, formyl, cyano, C₆-C₁₅ aryloxy and C₆-C₁₅ aryl.

More particularly, R₁ is selected from the group consisting of a C₂-C₁₅ alkylene and a C₆-C₃₀ arylene; R₂ is selected from the group consisting of a C₁-C₂₀ alkylene and a C₆-C₃₀ arylene; and R₃ is a linear or branched C₂-C₁₄ alkylene.

Preferably, R₂ is —(CH₂)ₙ— where n is the same as in recurring units (R_{PA}).

Preferably, the recurring units (R*_{PA}) do not comprise any aromatic ring.

The polyamide (PA) may be a copolyamide comprising the recurring units (R_{PA}) and also the recurring units (R*_{PA}) of formula (IV) derived from the condensation of at least one dicarboxylic acid and at least one diamine.

The polyamide (PA) may be a copolyamide comprising the recurring units (R_{PA}) and also the recurring units (R*_{PA}) of formula (V) derived from at least one aminocarboxylic acid and/or at least one lactam.

According to an embodiment, the recurring units of the copolyamide consist essentially of or consist of the recurring units (R_{PA}) and (R*_{PA}).

According to an embodiment, the proportion of the recurring units (R*_{PA}) in the copolyamide is generally between 1.0 mol % and 25.0 mol %. This proportion is preferably between 5.0 mol % and 20.0 mol %. According to an embodiment, the proportion of recurring units (R*_{PA}) is lower than 2.0 mol %, even lower than 1.0 mol % or lower than 0.5 mol %.

The copolyamide is also prepared by polycondensation. In such case, the condensation mixture disclosed above further comprises at least one component selected from the group consisting of:
at least one dicarboxylic acid and at least one diamine, and/or
at least one aminocarboxylic acid, and/or
at least one lactam.

The aminocarboxylic acid may have from 3 to 15 carbon atoms, for example from 4 to 13 carbon atoms. The aminocarboxylic acid may more particularly be selected in the group consisting of 6-amino-hexanoic acid, 9-aminononanoic acid, 10-aminoundecanoic acid, 11-aminoundecanoic acid, 12-aminododecanoic acid, 13-aminotridecanoic acid and mixtures thereof.

The lactam may have from 3 to 15 carbon atoms, for example from 4 to 13 carbon atoms. The lactam may more particularly be selected in the group consisting of caprolactam, laurolactam, dodecanolactam and mixtures thereof.

The dicarboxylic acid may be aliphatic or aromatic. Non limitative examples of aliphatic dicarboxylic acids are notably oxalic acid (HOOC—COOH), malonic acid (HOOC—CH₂—COOH), succinic acid [HOOC—(CH₂)₂—COOH], glutaric acid [HOOC—(CH₂)₃—COOH], 2,2-dimethyl-glutaric acid [HOOC—C(CH₃)₂—(CH₂)₂—COOH], adipic acid [HOOC—(CH₂)₄—COOH], 2,4,4-trimethyl-adipic acid [HOOC—CH(CH₃)CH₂—C(CH₃)₂—CH₂—COOH], pimelic acid [HOOC(CH₂)₅—COOH], suberic acid [HOOC—(CH₂)₆—COOH], azelaic acid [HOOC—(CH₂)₇—COOH], sebacic acid [HOOC—(CH₂)₈—COOH], undecanedioic acid [HOOC—(CH₂)₉—COOH], dodecandioic acid [HOOC—(CH₂)₁₀—COOH], tridecanedioic acid [HOOC—(CH₂)₁₁—COOH], tetradecanedioic acid [HOOC—(CH₂)₁₂—COOH], pentadecanedioic acid [HOOC—(CH₂)₁₃—COOH], hexadecanedioic acid [HOOC—(CH₂)₁₄—COOH], octadecanedioic acid [HOOC—(CH₂)₁₆—COOH]. Included in this category are also cycloaliphatic dicarboxylic acid such as 1,4-cyclohexane dicarboxylic acid. Non limitative examples of aromatic diacids are notably phthalic acids, including isophthalic acid (IPA), terephthalic acid (TPA), naphthalendicarboxylic acids (e.g. naphthalene-2,6-dicarboxylic acid), 4,4′-bibenzoic acid, 2,5-pyridinedicarboxylic acid, 2,4 pyridinedicarboxylic acid, 3,5-pyridinedicarboxylic acid, 2,2 bis (4 carboxyphenyl)propane, bis(4-carboxyphenyl)methane, 2,2 bis (4 carboxyphenyl)hexafluoropropane, 2,2-bis(4-carboxyphenyl)ketone, 4,4′ bis(4-carboxyphenyl)sulfone, 2,2-bis(3-carboxyphenyl)propane, bis(3-carboxyphenyl)methane, 2,2-bis(3-carboxyphenyl)hexafluoropropane, 2,2 bis(3-carboxyphenyl)ketone, bis(3-carboxyphenoxy)benzene.

The diamine may be aliphatic or aromatic. Non limitative examples of aromatic diamines are notably m-phenylene diamine (MPD), p-phenylene diamine (PPD), 3,4′-diaminodiphenyl ether (3,4′ ODA), 4,4′-diaminodiphenyl ether (4,4′-ODA), p-xylylene diamine (PXDA) and m-xylylenediamine (MXDA). Non limitative examples of aliphatic diamines are notably 1,2 diaminoethane, 1,2-diaminopropane, propylene-1,3-diamine, 1,3 diaminobutane, 1,4-diaminobutane (putrescine), 1,5-diaminopentane (cadaverine), 2-methyl-1,5-diaminopentane, hexamethylenediamine (or 1,6-diaminohexane), 3-methylhexamethylenediamine, 2,5 dimethylhexamethylenediamine, 2,2,4-trimethyl-hexamethylenediamine, 2,4,4-trimethyl-hexamethylenediamine, 1,7-diaminoheptane, 1,8-diaminooctane, 2,2,7,7-tetramethyloctamethylenediamine, 1,9-diaminononane, 2-methyl-1,8-diaminooctane, 5-methyl-1,9-diaminononane, 1,10-diaminodecane, 1,11-diaminoundecane, 1,12 diaminododecane, 1,13 diaminotridecane, 2,5-diamonotetrahydrofurane and N,N-Bis(3-aminopropyl)methylamine. Included in this category are also cycloaliphatic diamine, such as isophorone diamine, 1,3-diaminocyclohexane, 1,4-diaminocyclohexane, bis-p-aminocyclohexylmethane, 1,3-bis(aminomethyl)cyclohexane, 1,4-bis(aminomethyl)cyclohexane, 4,4′-methylene-bis-(2-methylcyclohexylamine). The aliphatic diamines can also be selected in the group of polyetherdiamines. The polyetherdiamines can be based on an ethoxylated (EO) backbone and/or on a propoxylated (PO) backbone and they can be ethylene-oxide terminated, propylene-oxide terminated or butylene-oxide terminated diamines. Such polyetherdiamines are for example sold under the trade name Jeffamine(R) and Elastamine(R) (Hunstman).

The copolyamide is also prepared by polycondensation. All what is disclosed above for the preparation of the homopolyamides remains valid for the copolyamide.

### End-Groups of the Polyamide (PA)

The end-groups of the polyamide (PA) are selected in the group of —NH₂, —COOH and amide end-groups. Indeed, the end-groups in the polyamide (PA) may be —NH₂ or —COOH. Yet, when the polycondensation involves the addition of an end-capping agent, these end-groups may be converted, partially or totally, into amide end-groups.

The amide end groups are of formula —NH—C(═O)—R where R is an an alkyl group, an aryl group or a cycloalkyl group and/or of formula —C(═O)—NH—R′ where R′ is an alkyl group or a cycloalkyl group. R is more particularly a linear or branched C₂-C₁₈ alkyl group or a C₅-C₁₀ cycloalkyl group. R′ is more particularly a linear or branched C₂-C₁₈ alkyl group.

The amide end groups of formula —NH—C(═O)—R result from the reaction of the end-groups —NH₂ with a monocarboxylic acid (end-capping agent) of formula R—COOH.

The monocarboxylic acid (end-capping agent) may advantageously be selected in the group consisting of benzoic acid; cyclohexanoic acid; R—COOH where R is a linear or branched C₂-C₁₈ alkyl group and combination of two or more of these acids. R is the radical derived from the acid of formula R—COOH.

The monocarboxylic acid (end-capping agent) may more particularly be selected in the group consisting of acetic acid, propanoic acid, butyric acid, valeric acid, caproic acid, lauric acid, stearic acid, 2-ethylhexanoic acid, cyclohexanoic acid, benzoic acid and combination of two or more of these acids.

The monocarboxylic acid (end-capping agent) is more particularly of formula CH₃—(CH₂)ₘ—COOH where m is an integer between 0 and 16. The amide end groups are then of formula —NH—C(═O)—(CH₂)ₘ—CH₃.

The amide end groups of formula —C(═O)—NH—R′ result from the reaction of the end-groups-COOH with a primary amine (end-capping agent) of formula R′—NH₂.

The primary amine (end-capping agent) may advantageously be selected in the group consisting of the amines of formula R′—NH₂ where R′ is a linear or branched C₂-C₁₈ alkyl group. R′ is the radical derived from the amine of formula R′—NH₂.

The primary amine (end-capping agent) is more particularly of formula CH₃—(CH₂)ₘ′—NH₂ where m′ is an integer between 2 and 18. The amide end groups are then of formula —C(═O)—NH—(CH₂)ₘ′—CH₃.

The primary amine (end capping agent) may more particularly be selected in the group consisting of propyl amine, butylamine, pentylamine, hexylamine, 2-ethylhexylamine, n-octylamine, n-dodecylamine, n-tetradecylamine, n-hexadecylamine, stearylamine, cyclohexylamine and combination of two or more of these amines.

The proportion of the end groups can be quantified by ¹H NMR or by potentiomtric techniques.

The polyamide (PA) is semi-crystalline.

The polyamide (PA) preferably exhibits a heat of fusion Hm of at least 15.0 J/g, preferably at least 18.0 J/g. Hm is determined on the 2^{nd} heat scan in differential scanning calorimeter (DSC) according to ISO11357, using a heating rate of 20° C./min.

The polyamide (PA) preferably exhibits a melting temperature (Tm) lower than 280° C. Tm may be between 200° C. and 280° C., preferably between 220° C. and 270° C., preferably between 225° C. and 270° C. Tm may be at least 230° C. Tm is determined on the 2^{nd} heat scan in differential scanning calorimeter (DSC) according to ISO11357, using a heating and a cooling rate of 20° C./min. The conditions of the protocol provided in the experimental section may be followed to determine Tm.

The polyamide (PA) may also exhibit a glass temperature (Tg) higher than 120° C. Tg may be at least 130° C. Tg may be between 120° C. and 160° C., preferably between 130° C. and 170° C. The glass temperature is determined on the 2nd heat scan in differential scanning calorimeter (DSC) according to ISO11357, using heating and cooling rates of 20° C./min. The conditions of the protocol provided in the experimental section may be followed to determine Tg.

The polyamide (PA) may have a number average molecular weight Mn ranging from 5,000 g/mol to 40,000 g/mol, for example from 7,000 g/mol to 35,000 g/mol or from 9,000 to 30,000 g/mol.

Mn can be determined using the following equation (1): Mn=2,000,000/[EG] (1) wherein [EG] is the proportion of end-groups in the PA expressed in mmol/kg. more precisely known methods to measure amine end-groups concentration and acid end groups-concentrations. The end-groups in the polyamide (PA) are generally amine and/or acid moieties. Yet, when the polycondensation involves the addition of an end-capping agent, the amine end-groups are converted, partially or totally, into modified end-group(s). For instance, when the end-capping is an acid such as benzoic acid or acetic acid, the remaining amine groups may be totally or partially converted into benzamide or acetamide end groups.

The concentration of the end-groups is determined according to techniques well-known to the skilled person. The amine and acid groups are usually determined by potentiometric titration. ¹H NMR may also be conveniently used.

The polyamide (PA) has preferably a water uptake at saturation, by immersion in water at 23° C., of less than 6.0 wt. %, preferably less than 5.0 wt. %, less than 4.0 wt. %.

The polymer composition (P) also preferably has a water uptake at saturation, by immersion in water at 23° C., of less than 6.0 wt. %, preferably less than 5.0 wt. %, less than 4.0 wt. %.

The water uptake at 23° C. is determined by (i) providing a specimen shaped according to ISO527 in its dry state (moisture content of less than 0.2 wt. %), (ii) immersing the same in deionized water at 23° C., until reaching a constant weight, (iii) calculating the water uptake with the formula:

$$Water uptake = \frac{{W}_{after} - {W}_{before}}{{W}_{before}} \times 100$$

wherein W_{before} is the weight of the shaped specimen in its original dry state and W_{after} is the weight of the shaped specimen after water uptake.

### Bio Based Content

In addition to the need for better thermal and thermomechanical performance, there is also a recent need to develop polyamide filaments produced from renewable resources, notably from biobased feedstocks.

The polyamide (PA) may exhibit a biobased content of at least 40.0 wt %, preferably at least 45.0 wt %, the biobased content being expressed as the % of organic carbon of renewable origin in the polyamide (PA) and measured according to ASTM D6866-22. A polymer having a biobased content of 100% has all its carbon atoms of a renewable origin.

This biobased content can be reached through the use of a biobased diacid of formula (III). For instance, sebacic acid (generally obtained industrially from castor oil) or azelaic acid (see Polymers (Basel), 2021 13 (23), p. 4091.doi: 10.3390/polym13234091) can be biobased.

The biobased content is defined as the % of organic carbon of renewable origin. It corresponds to the amount of C calculated from measured 14° C. percent in the sample and corrected for isotopic fraction.

According to an embodiment, biobased PACM may be used in the preparation of the polyamide (PA). Biobased PACM may be prepared from biobased toluene and aniline by hydrogenation of the corresponding aromatic diamines according to EP 0618188. Biobased aromatics (BTX) can be prepared according to ACS Sustainable Chem. Eng. 2018, 6, 3472-3480 from black liquors which are formed in the paper production by the digestion of pulpwood. The general scheeme of preparation of biobased PACM can thus be following: black liquor=>biobased toluene=>biobased aniline=>PACM.

With the use of a biobased PACM, the biobased content of the polyamide (PA) may be at least 80.0 wt %, preferably at least 85.0 wt %, preferably at least 90.0 wt %, preferably at least 99.5 wt %.

Through the use of biobased monomers and amide end-groups, the biobased content of the polyamide (PA) can also be 100 wt %. The biobased content may thus be between 80.0 and 100.0 wt %.

### Method of Preparation of the Filament of the Invention

The filament of the present invention is prepared by extruding the polymer composition (P). One can use an extruder to melt and extrude the polymer composition (P). The diameter of the filament can be modified by adapting the size of the die or nozzle and/or adjusting the draw ratio of filament after exit from the die.

As mentioned above, as the filament of the invention preferably does not present a core/shell geometry, the filament is preferably not prepared by coextrusion.

The polymer composition (P) may be prepared by mixing the components of the composition, the polymeric component(s) being in the molten form.

Melt-mixing processes are typically carried out by heating the polymer components above a suitable temperature to melt them. Suitable melt-mixing apparatus are, for example, kneaders, Banbury mixers, single-screw extruders, and twin-screw extruders. Preferably, use is made of an extruder fitted with means for dosing all the desired components to the extruder, either to the extruder's throat or to the melt.

The order of combining the components during melt-mixing is not particularly limited. In one embodiment, the components can be mixed in a single batch, such that the desired amounts of each of them are added together and subsequently mixed. In other embodiments, a first sub-set of components can be initially mixed together and one or more of the remaining components can be added to the mixture for further mixing. For clarity, the total desired amount of each component does not have to be mixed as a single quantity.

The mixing of the components of the polymer composition (P) is performed until the polymer composition (P) is homogeneous.

According to an embodiment, the method of preparation of the filament is an integrated process in which the polymer composition (P) and the filaments are prepared in a one-step process.

The conditions given in the examples may be followed to prepare the filament according to the invention.

### Method for Manufacturing a 3D Object

The present invention also relates to a method for manufacturing a 3D object using an additive manufacturing (AM) system, such as an extrusion-based additive manufacturing system (for example FFF or FDM).

The 3D object or article obtainable by such method of manufacture can be used in a variety of final applications. Mention can be made in particular of implantable devices, medical devices, dental prostheses, brackets and complex shaped parts in the aerospace industry and under-the-hood parts in the automotive industry which require a high resistance temperature.

The method more particularly comprises the following steps:
advancing the filament of the invention to a print head;
heating the filament in the print head to a molten state (preferably the filament is heated at a temperature which is at least Tm+10° C.);
extruding the material in the molten state from a nozzle in the print head;
ensuring relative movement in X- and Y-directions of the print head to form the cross sectional shape of the 3D object; and/or
ensuring relative movement in the Z-direction of the print head to form the 3D object in elevation.

According to an embodiment, the method for manufacturing a 3D object with an AM system comprises a step consisting in extruding the composition (P) into a filament. This step may, for example, occur when printing or depositing strips or layers of filament. The method for manufacturing 3D objects with an extrusion-based AM system is also known as Fused Filament Fabrication technique (FFF) or Fused Deposition Modeling (FDM).

FFF/FDM 3D printers are, for example, commercially available from Apium, from Roboze, from Hyrel or from Stratasys, Inc. (under the trade name Fortus®).

The present invention relates also to an AM method for manufacturing a three-dimensional (3D) article, part or composite material, comprising extruding the filament described above.

The AM method of the present invention is preferably a Fused Filament Fabrication (FFF) method, also known as Fused Deposition Modelling (FDM).

In some embodiments, the method further comprises at least one of the following steps, in connection with the 3D printer:
feeding the filament to a discharge head member having a throughbore ending with a discharge tip and a circumferential heater to melt the filament in the throughbore;
heating the filament to a temperature of at least Tm+10° C., prior to extrusion;
compressing the filament with a piston, for example with the unmelted filament acting as a piston, in the throughbore;
ensuring relative movement in X- and Y-directions of the discharge tip and of a receiving platform while discharging the filament on the receiving platform to form the cross sectional shape; and/or
ensuring relative movement in the Z-direction of the discharge tip and the receiving platform while discharging the filament on the receiving platform to form the 3D object or part in elevation.

The 3D object may be built on substrate, for example a horizontal substrate and/or on a planar substrate. The substrate may be moveable in all directions, for example in the horizontal or vertical direction. During the 3D printing process, the substrate can, for example, be lowered, in order for the successive layer of polymeric material to be deposited on top of the former layer of polymeric material.

In some embodiments, the AM method for making a 3D object further comprises a step consisting in producing a support structure, using a support material. According to such embodiments, the 3D object is built upon the support structure and both the support structure and the 3D object are produced using the same AM method.

The 3D printer may comprise a chamber in order to maintain the filament at determined at a specific temperature. This temperature may be at approximately the Tg of the polyamide (PA), e.g. Tg±10° C.

While not strictly necessary, the 3D object may also be subjected to heat-treatment after manufacture (also called annealing or tempering). In this case, the 3D object is placed in an oven set up at a temperature ranging from 80 to 200° C., preferably from 100 to 180° C., for a period of time of ranging from about 30 minutes to 24 hours, preferably from 1 hour to 8 hours.

The conditions of the 3D printing method provided in the experimental section may be followed.

### 3D Object

The filament of the invention makes it possible to prepare a 3D object comprising the polyamide (PA) as described herein. The present invention also relates to the use of the filament described herein, for the manufacture of a 3D object using additive manufacturing, preferably FFF or FDM.

The present invention additionally relates to the use of a polyamide (PA) as described herein for the manufacture of a filament for use in the manufacture of three-dimensional objects.

### Experimental Section

### Raw Materials

PACM: 4,4′-methylene-bis-cyclohexylamine, containing 47 mol. % of trans/trans isomer, commercially available from BASF under the name Dicykan®
PACM*: 4,4′-methylene-bis-cyclohexylamine, containing 20 mol. % of trans/trans isomer, commercially available from Evonik under the name Vestamin® PACM
C6 diacid: adipic acid, commercially available from Invista
C9 diacid: azelaic acid, commercially available from Matrica. This diacid is biobsed from sunflower oil.
C10 diacid: sebacic acid, commercially available from Jayant Agro Organics Ltd. This diacid is biobased from castor oil.
C12 diacid: dodecanedioic acid, commercially available from Sigma-Aldrich. C12 diacid can be fossil based or biobased.
C13 diacid: brassylic acid, commercially available from Sigma-Aldrich. C13 diacid can be fossil based or biobased.
PA6: commercially available from DOMO Chemical

### Preparation of the Polyamides of the Examples

The polyamides were prepared by melt polycondensation of either PACM or PACM* and either C6, C9, C10, C12 or C13 diacids.

### Preparation of PACM.12

95.5 g of PACM (0.45 mol), 102.3 g of C12 diacid (0.44 mol), and 4.16 g of an aqueous solution of sodium hypophosphite monohydrate (5 wt %, 2 mmol) were introduced in a stainless-steel reactor equipped with a mechanical stirrer. The reactor was purged with nitrogen, and the temperature in the reactor was gradually increased up to 275° C. The reaction proceeded at atmospheric pressure. Condensation water as well as water from the catalyst solution were distilled off. The reaction mixture was kept at 275° C. for 30 min. The resulting polymer was then discharged as a strand and pelletized.

Preparation of PACM.9, PACM.10, PACM.13, PACM.6 (comparative), PACM*. 10 (comparative), PACM*. 9 (comparative):

The same procedure as for PACM.12 was applied for the preparation of these polyamides, but starting from different monomers. The preparation of PACM.6 was not successful as the polyamide crystallized during the reaction and did not melt at 275° C.: it will not be processable in the melt at reasonable temperature and is therefore not usable in 3D printing. For all of the other polyamides, there was no issue to produce them and they were all melt processable to be extruded from the reactor.

### Characterization of the Polyamides

TABLE 1

| | | |
|---|---|---|
| PACM.9 (inv) | n = 7 | Semi-crystalline |
| PACM.12 (inv) | n = 10 | Semi-crystalline |
| PACM.13 (inv) | n = 11 | Semi-crystalline |
| PACM.10 (inv) | n = 8 | Semi-crystalline |
| PACM.6 (comp) | / | Non processable |
| PACM*.10 (comp) | / | Amorphous |
| PACM*.9 (comp) | / | Amorphous |

### DSC

DSC protocol

The protocol used was the following: 1^{st} heat cycle from 30.00° C. to 300.00° C. at
20.00° C./min; isothermal for 5 minutes; 1^{st} cool cycle from 300.00° C. to 30.00° C.
at 20.00° C./min; 2^{nd} heat cycle from 30.00° C. to 300.00° C. at 20.00° C./min. The
melting temperature (Tₘ) is recorded during the 2^{nd} heat cycle and the glass
transition temperature (T_{g}) is recorded during the 2^{nd} heat cycle.

DSC analyses were carried out according to ISO11357 and data were collected through a two heat, one cool method.

The DSC used was DSC 8000 (Perkin Elmer).

### Water Uptake

The polyamides were shaped according to ISO527 in their dry state (moisture content of less than 0.2 wt. %), and then immersed in deionized water at 23° C., until reaching a constant weight.

### Tensile Properties

Tensile modulus, tensile strength and tensile elongation at break were measured according to ISO 527-2.

### Results

The strength, modulus, and elongation at break results in Table 2 were measured from injection molded specimens.

TABLE 2

| | Strength/ | | | |
|---|---|---|---|---|
| | Modulus/ | | | |
| | El. @break | Tm | Tg | Water |
| Polymer | (MPa) | (° C.) | (° C.) | uptake |
| PACM.12 (inv) | 60/1400/>50% | 250 | 137 | 3.5% |
| PACM.10 (inv) | | 268 | 150 | |
| PACM.9 (inv) | 66/1600/>50% | 255 | 145 | |
| PACM.6 (comp) | | 355 | | |
| PACM*.10 (comp) | | | 137 | |
| PACM*.9 (comp) | | | 141 | |
| PA6 (comp) | | 220 | 50 | 9% |

As shown in Table 2, the combination of PACM and C6 diacid does not provide a polyamide that can be processed at a reasonable temperature as it does not melt before 355° C. On the opposite, when PACM is combined with C9, C10, C12 and C13 diacids, the polyamides are all semi-crystalline and have a melting temperature below 280° C. and a Tg>130° C., which makes them suitable for melt processing under the shape of filaments and for applications where the parts will be exposed to temperatures higher than 160° C. We can also see that the polyamides of the invention exhibit a high modulus >1000 MPa with high elongation at break. Thus the filament of the invention can be well processed and ensures thermomechanical properties of the obtained 3D object.

The 3D objects prepared with the filament of the invention also exhibits UV resistance because the recurring units (R_{PA}) do not comprise any aromatic moiety.

When using PACM* in combination with C10 diacid or with C9 diacid, the polyamides are amorphous (they do not have a melting temperature) and only exhibits a Tg, which is not desired for filament production for 3D printing as it does not have any mechanical integrity at temperatures beyond 160° C. It is then desirable to use PACM that contains more than 30 mol % of trans-trans isomer.

### Filament Preparation and Characterization

Feed stocks for filament production consisted of neat polymer (PA) pellets. Filament of diameter 1.75 mm was prepared for each composition using a Brabender® Intelli-Torque Plasti-Corder® Torque Rheometer extruder equipped with a 0.75″ (1.905 cm) 32 L/D general purpose single screw, a heated capillary die attachment, a 3/32″ diameter nozzle with land of length 1.5″, and downstream, custom-designed filament conveying apparatus. Other downstream equipment included a belt puller and a Dual Station Coiler, both manufactured by ESI-Extrusion Services. A Beta LaserMike® 5012 with DataPro 1000 data controller was used to monitor filament dimensions. The melt strand was cooled with air. The Brabender® zone set point temperatures were 250-280° C. in the barrel zone and just above the melt temperature with the die at 270° C. The Brabender® speed ranged from 25 to 60 rpm and the puller speed from 20 to 70 feet per minute (6.093 to 21.336 m/min).

### 3D Printing

Filaments described above were printed on an Argo 500 extrusion-based additive manufacturing system commercially available from Roboze Inc., (Houston, Texas, USA, or Bara, Italy). Nylon build sheets were employed as the printed object substrate. During the printing trials, the extruder temperature was set between 30° and 390° C., and the heated chamber was set at approximately the Tg of the material e.g. at 130-150° C. A 0.6 mm Roboze Argo Tip3-HSA tip was used for the model material, with a 0.1 to 0.3 mm layer thickness. The material was extruded as a series of roads in a layer-by-layer fashion to print structures in the heated chamber. ASTM Type I, IV and V tensile bars were printed for each formulation, using 100% infill and either 45°/−45° alternating rasters or 0°/90° alternating rasters, and objects were promptly removed from the heated chamber and build sheet after printing. We observed that the PA filament of the invention has a good printing ability and exhibits high thermomechanical properties.

TABLE 3

| | Strength / Modulus (MPa) / El. |
|---|---|
| Polymer | @break (%) |
| PACM.12 (inv) | 50/1200/6.3% |
| PACM.9 (inv) | 51/1400/5.0% |

As can be seen in Table 3, the 3D object retains good mechanical properties.

1. A Filament comprising a polymer composition (P) comprising at least 50.0 wt. %, this proportion being based on the total weight of the polymer composition (P), of at least one polyamide (PA) comprising the recurring units (R_{PA}) of formula (I): 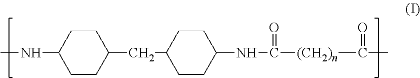
wherein:
the proportion of recurring units (R_{PA}) is at least 50.0 mol %, this proportion being relative to the total number of recurring units in the polyamide (PA);
n is an integer between 7 and 11; and
the proportion of the moieties derived from 4,4′-diaminodicyclohexylmethane in a trans/trans configuration being at least 30.0 mol. % and at most 60.0 mol %, this proportion being based on the total number of moles of the moieties derived from 4,4′-diaminodicyclohexylmethane in the polyamide (PA).

2. The Filament according to claim 1 wherein the proportion of polyamide(s) (PA) in the polymer composition (P) is at least 60.0 wt. %.

3. The Filament according to claim 1, wherein the polymer composition (P) consists of:
at least one polyamide (PA);
optionally at least one filler; and
optionally at least one additive other than a filler, notably selected in the group consisting of colorants, dyes, pigments, lubricants, plasticizers, flame retardants, tougheners, nucleating agents, heat stabilizers, light stabilizers, antioxidants, processing aids, fusing agents, electromagnetic absorbers and combination thereof.

4. The filament according to claim 1, wherein the polymer composition (P) comprises or consists of at least one polyamide (PA) and as additives: i) at least one filler and ii) optionally at least one additive other than a filler, notably selected in the group consisting of colorants, dyes, pigments, lubricants, plasticizers, flame retardants, tougheners, nucleating agents, heat stabilizers, light stabilizers, antioxidants, processing aids, fusing agents, electromagnetic absorbers and combination thereof.

5. (canceled)

6. (canceled)

7. (canceled)

8. (canceled)

9. (canceled)

10. The Filament according to claim 1, wherein the polyamide (PA) exhibits:
a glass temperature (Tg) higher than 120° C.; and/or
a melting temperature (Tm) lower than 280° C.

11. The Filament according to claim 1 wherein the proportion of 4,4′-diaminodicyclohexylmethane moieties in a trans/trans configuration is at least 40.0 mol. % and/or lower than 55.0 mol %.

12. (canceled)

13. (canceled)

14. The Filament according to claim 1 wherein the proportion of the recurring units (R_{PA}), based on the total number of recurring units in the polyamide (PA), is at least 60.0 mol %.

15. (canceled)

16. (canceled)

17. (canceled)

18. (canceled)

19. (canceled)

20. (canceled)

21. (canceled)

22. (canceled)

23. The Filament according to claim 1, wherein the polymer composition (P) does not comprise a polyamide other than the polyamide(s) (PA).

24. (canceled)

25. (canceled)

26. The Filament according to claim 1, wherein the components of the polymer composition (P) are blended together.

27. (canceled)

28. (canceled)

29. (canceled)

30. (canceled)

31. (canceled)

32. (canceled)

33. The Filament according to claim 1 having a cylindrical or substantially cylindrical geometry and having a diameter d between 0.5 mm and 5.0 mm.

34. The Filament according to claim 1, wherein the composition of the filament consists of the polymer composition (P).

35. (canceled)

36. The Filament according to claim 1, wherein the filament does not present a core/shell geometry.

37. The Filament according to claim 1, wherein the filament is prepared by extruding the composition (P).

38. (canceled)

39. (canceled)

40. A spool of filament according to claim 37.

41. A Method for manufacturing a 3D object comprising printing the 3D object from a filament according to claim 37 using an additive manufacturing system.

42. (canceled)

43. (canceled)

44. (canceled)

45. The Filament according to claim 1 wherein the proportion of polyamide(s) (PA) in the polymer composition (P) is at least 80.0 wt. %.

46. The Filament according to claim 1 wherein the proportion of the recurring units (R_{PA}), based on the total number of recurring units in the polyamide (PA), is at least 80.0 mol %.

47. The Filament according to claim 1 wherein the proportion of the recurring units (R_{PA}), based on the total number of recurring units in the polyamide (PA), is at least 90.0 mol %.

48. The Filament according to claim 1 wherein the polyamide (PA) consists essentially of recurring units (R_{PA}).

49. The Filament according to claim 1 wherein the polyamide (PA) consists of recurring units (R_{PA}).
